(19) United States
(12) Patent Application Publication
(10) Pub. No.: US 2024/0183695 A1
(43) Pub. Date: Jun. 6, 2024

(54) SENSOR CALIBRATION USING DISTRIBUTED STOCHASTIC PARAMETER ESTIMATION

(71) Applicant: International Business Machines Corporation, Armonk, NY (US)

(72) Inventor: Subhro Das, Cambridge, MA (US)

(73) Assignee: International Business Machines Corporation, Armonk, NY (US)

(21) Appl. No.: 18/072,881

(22) Filed: Dec. 1, 2022

(51) Int. Cl. G01D 18/00

(52) U.S. Cl. CPC G01D 18/00; H04L 67/12

(57) ABSTRACT

Using a first sensor device in a network of sensor devices, sensor data is measured. A second sensor device comprising a trusted sensor device is selected from the network of sensor devices. A gain matrix is updated. Using the gain matrix, the sensor data, and a second parameter estimate received from the second sensor device, a first parameter estimate is updated. The first parameter estimate comprises an estimate of a parameter of a model representing the first sensor device. Using the gain matrix, an estimation error covariance matrix and a cross-variance matrix are updated. Using the updated first parameter estimate, second sensor data measured by the first sensor device is adjusted.

### BACKGROUND

The present invention relates generally to a method, system, and computer program product for sensor network management. More particularly, the present invention relates to a method, system, and computer program product for sensor calibration using distributed stochastic parameter estimation.

Sensor devices, as used herein, are devices that include one or more sensors, which collect data of an object or environment around a sensor device, as well as a processor, software, and an ability to exchange data with other devices or systems over a communications network. Some non-limiting examples of sensor devices measure temperature, humidity, pressure, voltage, electrical current, water flow, biomedical parameters such as heart rate and blood sugar, distance, speed, acceleration, changes in direction, speed, and acceleration, air quality, and amounts of a particular gas. Microphones and still or video cameras are also often implemented in sensor devices, to collect sound and image data. Sensor devices are often implemented in groups. Multiple instances of the same sensor are often used to monitor different portions of a location, and a group of different sensors is often used to monitor different aspects of a location. For example, multiple cameras or air quality sensor devices might be used to monitor different rooms or floors of a building, and temperature, humidity, wind direction and speed, and cloud height sensors are typically used to monitor weather conditions at an airport.

A sensor network is a network of spatially dispersed sensor devices. Each sensor device is thus a node in a sensor network. In some sensor networks, each device forwards the collected data to a central location, while in other sensor networks, each device does not routinely forward collected data, but instead forwards a derivation of the collected data to the central location. For example, a sensor network might include a set of water temperature sensor devices deposited on the ocean floor, each reporting a water temperature reading to a central location once per hour. Another example sensor network might include a set of smoke and carbon monoxide sensor devices placed on the ceiling of a large warehouse, configured to generate an alert to a central location when a measured amount of smoke or carbon monoxide exceeds a threshold value.

Sensor data, as measured, often requires conversion from the raw measurement to data of interest. For example, the raw data may require a noise reduction process, a temperature correction factor to be applied, or the like. Conversion from the raw measurement to data of interest often requires a calibration process, to ensure a desired accuracy of reported measurements. In other words, in a model representing the device, calibration is the process of setting a parameter of the model. A deterministic model is one in which state variables of the model are uniquely determined by the model's parameters and previous states of the state variables. However, although deterministic values produce unique solutions, such models are often oversensitive to input perturbations. A stochastic model has state variables and model parameters that are described by probability distributions instead of unique values, so that an output of the model is also a probability distribution instead of a unique value.

### SUMMARY

The illustrative embodiments provide a method, system, and computer program product. An embodiment includes a method that measures, using a first sensor device in a network of sensor devices, sensor data. An embodiment selects, from the network of sensor devices, a second sensor device, the second sensor device comprising a trusted sensor device. An embodiment updates a gain matrix. An embodiment updates, using the gain matrix, the sensor data, and a second parameter estimate received from the second sensor device, a first parameter estimate, the first parameter estimate comprising an estimate of a parameter of a model representing the first sensor device, the updating resulting in an updated first parameter estimate. An embodiment updates, using the gain matrix, an estimation error covariance matrix and a cross-variance matrix. An embodiment adjusting, using the updated first parameter estimate, second sensor data measured by the first sensor device.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for sensor calibration using distributed stochastic parameter estimation in accordance with an illustrative embodiment;

FIG. 3 depicts an example configuration for sensor calibration using distributed stochastic parameter estimation in accordance with an illustrative embodiment;

FIG. 4 depicts example pseudocode for use in implementing sensor calibration using distributed stochastic parameter estimation in accordance with an illustrative embodiment;

FIG. 5 depicts definitions for terms used in implementing sensor calibration using distributed stochastic parameter estimation in accordance with an illustrative embodiment;

FIG. 6 depicts a flowchart of an example process for sensor calibration using distributed stochastic parameter estimation in accordance with an illustrative embodiment.

### DETAILED DESCRIPTION

The illustrative embodiments recognize that calibrating a sensor device can be performed by computing, or learning, a parameter of a model representing the device. A parameter of a model representing a sensor device is referred to herein as a device parameter. There are also other reasons for obtaining an accurate estimate of a device parameter. The illustrative embodiments also recognize that device parameter computation can be improved by incorporating data from other devices in the network into the parameter computation process. One method of incorporating data from other devices is federated learning, in which all devices in a network report their data to a fusion server. The fusion server updates one or more global parameters and distributes the updated parameters to each network device for local use. However, because each device must report to the same server, devices in a geographically distributed network are often required to communicate over long distances. The longer the distance a communication travels, the more power is typically required, and thus federated learning often has a higher-than-acceptable power requirement, particularly in battery powered sensor networks spanning long distances (e.g., hundreds of miles of ocean floor). In addition, if the fusion server is unavailable, the entire sensor network becomes unreliable or unusable. As well, in federated learning all devices send their data to the fusion server, and there are applications in which sending sensor data or pooling the data from dispersed devices in one location, is undesirable or not allowed, for security or other reasons. Also, the global parameter may not apply to all devices in a network, and federated learning lacks the flexibility to implement a parameter for only a subset of the network. Thus, the illustrative embodiments recognize that there is a need for a different parameter computation method without a fusion center, in which data is distributed only among a subset of trusted agents (other sensor devices in the network).

The illustrative embodiments recognize that deterministic models are often oversensitive to input perturbations. Thus, the illustrative embodiments recognize that there is a need to model a sensor device using a stochastic model, and thus a need to compute a stochastic parameter of the model.

The illustrative embodiments recognize that the presently available tools or solutions do not address these needs or provide adequate solutions for these needs. The illustrative embodiments used to describe the invention generally address and solve the above-described problems and other problems related to sensor calibration using distributed stochastic parameter estimation.

An embodiment can be implemented as a software application. The application implementing an embodiment can be configured as a modification of an existing sensor network management system, as a separate application that operates in conjunction with an existing sensor network management system, a standalone application, or some combination thereof.

Particularly, some illustrative embodiments provide a method that, using a first sensor device in a network of sensor devices, measures sensor data, uses the sensor data and a second parameter estimate received from a second sensor device in the network to update a first parameter estimate, and uses the updated first parameter estimate to adjust second sensor data measured by the first sensor device.

An embodiment uses a first sensor device in a network of sensor devices to measure sensor data. The sensor data is raw sensor measurement data, to be adjusted using a stochastic model representing the device. In mathematical terms, if i is a sensor device in the network, from 1 to the number of sensor devices in the network (denoted by m), and the timestamp of a measurement is denoted by k, raw sensor data z_{i,k} is represented by the expression z_{i,k}=Hᵢθ+v_{i,k}, where Hᵢ denotes a measurement matrix, v_{i,k} denote measurement noise, and θ denotes a vector parameter of the model. The measurement matrix represents which elements of the parameter θ are represented in the measurement z_{i,k} and shows how those elements are represented. Thus, to use the model, an embodiment needs to determine a parameter estimate for θ in the expression. That estimate is denoted herein by x_{i,k} for sensor device i at time k.

An embodiment implemented in sensor device i (embodiment i) receives model parameter estimates from one or more other sensor devices in the network of sensor devices. A model parameter estimate from another embodiment, implemented in sensor device j is denoted herein by x_{j,k}. An embodiment implemented in sensor device j (embodiment j) is thus trusted as a source of model parameter estimate data. Although there must be at least four sensor devices in the network of sensor devices, not all sensor devices in the network of sensor devices need be available or trusted as sources of model parameter estimate data. Instead, at least one other sensor device needs to be available as a source of model parameter estimate data. For example, one embodiment i might trust the geographically closest sensor device in the network, the four geographically closest sensor devices in the network, any device in the network that has a direct communication connection (without any intervening devices) to the embodiment, devices with direct connections to more than a threshold number of other devices, any device in the network with a communication latency lower than a threshold value, randomly selected devices (selected using a pseudo-random number generator), or use other criteria to determine which sensor devices to trust as sources of model parameter estimate data.

Embodiment i uses sensor data z_{i,k} and parameter estimate x_{j,k} to update its own parameter estimate, denoted herein by x_{i,k+1}. In particular, embodiment i performs k iterations of parameter estimation.

To begin, at iteration 0, embodiment i initializes an estimation error covariance matrix, denoted by P_{i,0}, to an n-by-n identity matrix (if no prior statistics from a previous set of parameter estimation iterations are available) or to the covariance matrix Σ_{θ} (denoting the covariance of stochastic parameter θ) if available from a previous set of parameter estimation iterations. At iteration 0, embodiment i also initializes a cross-covariance matrix between estimation errors of devices i and j, denoted by P_{ij,0}, to an n-by-n identity matrix (if no prior statistics from a previous set of parameter estimation iterations are available) or to covariance matrix Σ_{θ} if available from a previous set of parameter estimation iterations. At iteration 0, embodiment i also initializes x_{i,0} to an n-by-n matrix of zeroes (if no prior statistics from a previous set of parameter estimation iterations are available) or to a previous value of θ if available from a previous set of parameter estimation iterations.

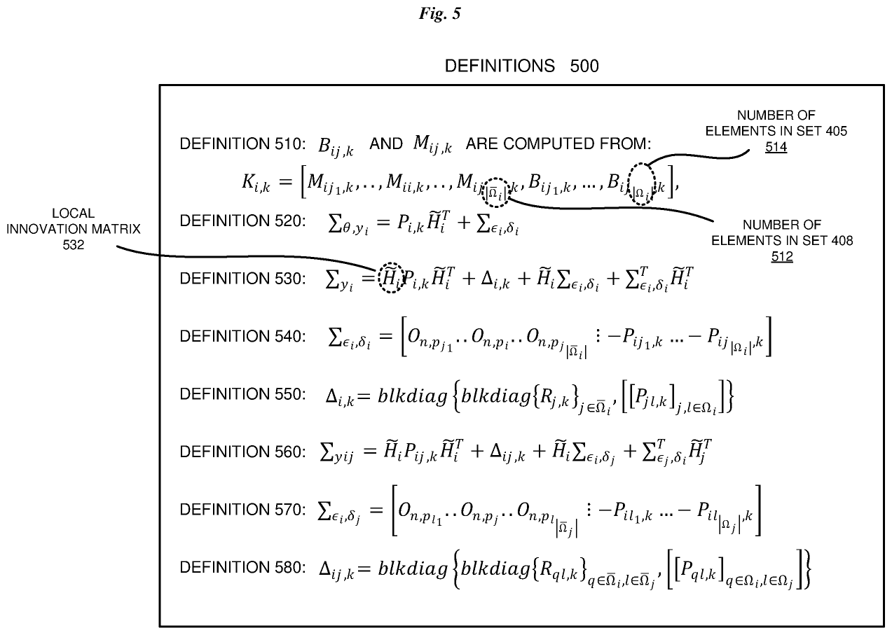

Once embodiment i initializes estimation error covariance matrix P_{i,0} and cross-covariance matrix between estimation errors of devices i and j P_{ij,0}, embodiment i computes a gain matrix, denoted by K_{i,k}, using the expression K_{i,k}=Σ_{θ,yi}Σ_{yi}⁻¹. In the expression, covariance matrix Σ_{θ,yi} represents the cross-covariance between the parameter θ and the innovations of node i, and is computed using definitions 520 and 570 in FIG. 5. As well, covariance matrix Σ_{yi} represents the covariance of the innovations of node i and is computed using definitions 530, 550, and 570 in FIG. 5.

Embodiment i uses the gain matrix K_{i,k}, to compute an updated parameter estimate x_{i,k+1}. In particular, embodiment i computes a sum of B_{ij,k}(x_{j,k}−x_{i,k}) for all the adjacent sensor devices j except device i, computes a sum of M_{ij,k}(z_{j,k}−Hⱼx_{i,k}) for all the adjacent sensor devices j including device i, and adds both sums to x_{i,k}. The result is updated parameter estimate x_{i,k+1}. B_{ij,k} denotes local consensus weight matrices, and M_{ij,k} denotes local innovation weight matrices. In the sum, B_{ij,k} and M_{ij,k} are components of gain matrix K_{i,k}, computed using definition 510 in FIG. 5. Embodiment i also, optionally, communicates updated parameter estimate x_{i,k+1} to embodiment j for use in embodiment j's own parameter update process.

Embodiment i also uses the gain matrix K_{i,k}, to compute an updated estimation error covariance matrix, denoted by P_{i,k+1}, and an updated cross-covariance matrix between estimation errors of devices i and j, denoted by P_{ij,k+1}. The estimation error covariance matrix and cross-covariance matrix between estimation errors of devices i and j are the covariance of the error in parameter estimation, and reflect how far are the parameter estimates from their true value. Hence, these matrices are useful in proportionately weighing the new measurements so that the parameter estimates get closer and closer to the true values. In particular, embodiment i computes P_{i,k+1} by subtracting K_{i,k} Σ_{θ,yi}^{T} from the previous value of the estimation error covariance matrix (denoted by P_{i,k}). Σ_{θ,yi}^{T} is a transposition of Σ_{θ,yi}. Embodiment i computes P_{ij,k+1} using the expression P_{ij,k+1}=P_{ij,k}−K_{i,k} Σ_{θ,yi}^{T}−Σ_{θ,yi} K_{j,k}^{T}+K_{i,k} Σ_{yi,j} K_{j,k}^{T} for all adjacent devices j not including device i. from the previous value of the estimation error covariance matrix (denoted by P_{i,k}). Σ_{yi,j} denotes a covariance matrix computed using definitions 560 and 580 in FIG. 5.

Embodiment i determines whether the updated parameter estimate x_{i,k+1} computed in iteration k meets a completion condition. If not, embodiment i performs one or more additional iterations, until a completion condition is reached. Some non-limiting examples of a completion condition are a change in the updated parameter estimate that is smaller than a threshold amount or a threshold percentage (indicating that the iteration process has converged on a particular parameter estimate), and that a number of iterations has exceeded a threshold number (indicating that the iteration process is not converging and should be stopped). One non-limiting example of a threshold percentage is 0.01%.

Embodiment i uses the updated parameter estimate to adjust raw sensor data measured by its sensor device. The result is calibrated sensor data. In particular, if the raw sensor data at time k is denoted by x_{i,k}, the calibrated sensor data is Hᵢ*x_{i,k}.

An embodiment periodically repeats the iterations of the parameter estimation process. For example, an embodiment might repeat the process every hour, or every six, twelve, or twenty-four hours. The time period selected depends on the sensors and the application in which they are used.

The manner of sensor calibration using distributed stochastic parameter estimation described herein is unavailable in the presently available methods in the technological field of endeavor pertaining to sensor devices. A method of an embodiment described herein, when implemented to execute on a device or data processing system, comprises substantial advancement of the functionality of that device or data processing system in using a first sensor device in a network of sensor devices, measuring sensor data, using the sensor data and a second parameter estimate received from a second sensor device in the network to update a first parameter estimate, and using the updated first parameter estimate to adjust second sensor data measured by the first sensor device.

The illustrative embodiments are described with respect to certain types of matrices, model parameters, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

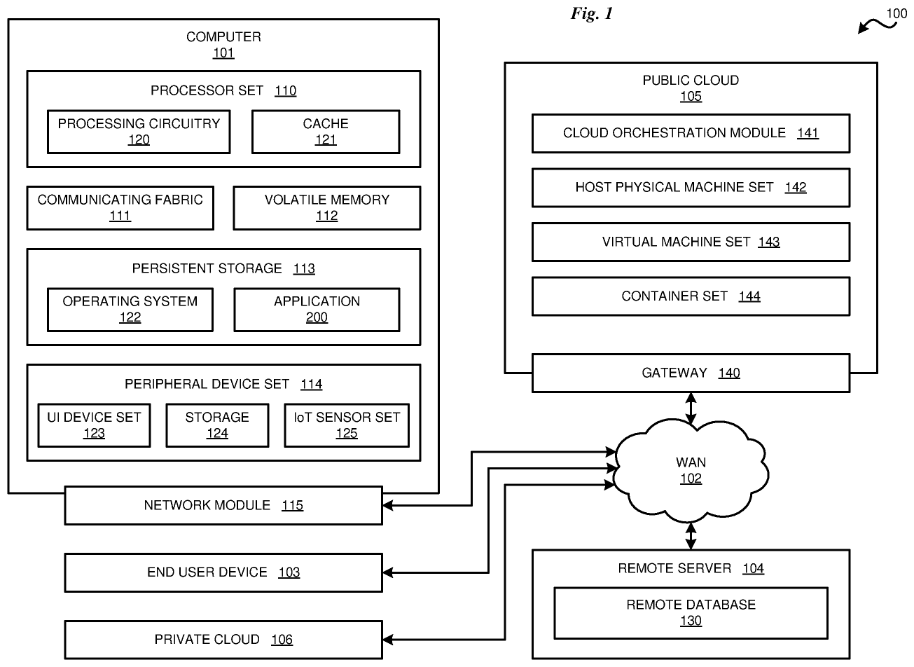

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a sensor calibration using distributed stochastic parameter estimation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, a computer in public cloud 105 or private cloud 106, or a sensor in sensor set 125 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

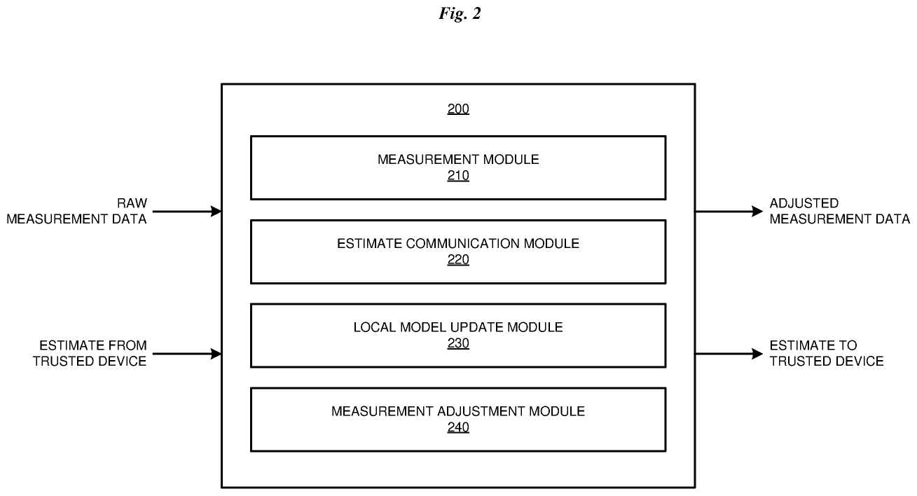

With reference to FIG. 2, this figure depicts a block diagram of an example configuration for sensor calibration using distributed stochastic parameter estimation in accordance with an illustrative embodiment. Application 200 is the same as application 200 in FIG. 1.

Measurement module 210 uses a first sensor device in a network of sensor devices to measure sensor data. The sensor data is raw sensor measurement data, to be adjusted using a stochastic model representing the device. In mathematical terms, if i is a sensor device in the network, from 1 to the number of sensor devices in the network (denoted by m), and the timestamp of a measurement is denoted by k, raw sensor data z_{i,k} is represented by the expression z_{i,k}=Hᵢθ+v_{i,k}, where Hᵢ denotes a measurement matrix, v_{i,k} denote measurement noise, and θ denotes a vector parameter of the model. Thus, to use the model, application 200 needs to determine a parameter estimate for θ in the expression. That estimate is denoted herein by x_{i,k} for sensor device i at time k.

Estimate communication module 220 receives model parameter estimates from one or more other sensor devices in the network of sensor devices (each executing another instance of application 200). A model parameter estimate from another device, implemented in sensor device j is denoted herein by x_{j,k}. Sensor device j is thus trusted as a source of model parameter estimate data. Not all sensor devices in the network of sensor devices need be available or trusted as sources of model parameter estimate data. For example, one implementation of application 200 might trust the geographically closest sensor device in the network, the four geographically closest sensor devices in the network, any device in the network that has a direct connection (without any intervening devices) to the embodiment, devices with direct connections to more than a threshold number of other devices, any device in the network with a communication latency lower than a threshold value, randomly selected devices (selected using a pseudo-random number generator), or use other criteria to determine which sensor devices to trust as sources of model parameter estimate data.

Local model update module 230, executing in device i, uses sensor data z_{i,k} and parameter estimate x_{j,k} to update its own parameter estimate, denoted herein by x_{i,k+1}. In particular, module 230 performs k iterations of parameter estimation.

To begin, at iteration 0, module 230 initializes an estimation error covariance matrix, denoted by P_{i,0}, to an n-by-n identity matrix (if no prior statistics from a previous set of parameter estimation iterations are available) or to the covariance matrix Σ_{θ} (denoting the covariance of stochastic parameter θ) if available from a previous set of parameter estimation iterations. At iteration 0, module 230 also initializes a cross-covariance matrix between estimation errors of devices i and j, denoted by P_{ij,0}, to an n-by-n identity matrix (if no prior statistics from a previous set of parameter estimation iterations are available) or to covariance matrix Σ_{θ} if available from a previous set of parameter estimation iterations. At iteration 0, module 230 also initializes x_{i,0} to an n-by-n matrix of zeroes (if no prior statistics from a previous set of parameter estimation iterations are available) or to a previous value of θ if available from a previous set of parameter estimation iterations.

Once module 230 initializes estimation error covariance matrix P_{i,0} and cross-covariance matrix between estimation errors of devices i and j P_{ij,0}, module 230 computes a gain matrix, denoted by K_{i,k}, using the expression K_{i,k}=Σ_{θ,yi}Σ_{yi}⁻¹. In the expression, covariance matrix Σ_{θ,yi} represents the cross-covariance between the parameter θ and the innovations of node i and is computed using definitions 520 and 570 in FIG. 5. As well, covariance matrix Σ_{yi} represents the covariance of the innovations of node i and is computed using definitions 530, 550, and 570 in FIG. 5.

Module 230 uses the gain matrix K_{i,k}, to compute an updated parameter estimate x_{i,k+1}. In particular, module 230 computes a sum of B_{ij,k}(x_{j,k}−x_{i,k}) for all the adjacent sensor devices j except device i, computes a sum of M_{ij,k}(z_{j,k}−Hⱼx_{i,k}) for all the adjacent sensor devices j including device i, and adds both sums to x_{i,k}. The result is updated parameter estimate x_{i,k+1}. In the sum, B_{ij,k} and M_{ij,k} are components of gain matrix K_{i,k}, computed using definition 510 in FIG. 5. Module 220 also, optionally, communicates updated parameter estimate x_{i,k+1} to device j for use in device j's own parameter update process.

Module 230 also uses the gain matrix K_{i,k}, to compute an updated estimation error covariance matrix, denoted by P_{i,k+1}, and an updated cross-covariance matrix between estimation errors of devices i and j, denoted by P_{ij,k+1}. In particular, module 230 computes P_{i,k+1} by subtracting K_{i,k} Σ_{ƒ,yi}^{T} from the previous value of the estimation error covariance matrix (denoted by P_{i,k}). Σ_{θ,yi}^{T} is a transposition of Σ_{θ,yi}. Module 230 computes P_{ij,k+1} using the expression P_{ij,k+1}=P_{ij,k}−K_{i,k} Σ_{θ,yi}^{T}−Σ_{θ,yi} K_{j,k}^{T}+K_{i,k} Σ_{yi,j} K_{j,k}^{T} for all adjacent devices j not including device i. from the previous value of the estimation error covariance matrix (denoted by P_{i,k}). Σ_{yi,j} denotes a covariance matrix computed using definitions 560 and 580 in FIG. 5.

Module 230 determines whether the updated parameter estimate x_{i,k+1} computed in iteration k meets a completion condition. If not, module 230 performs one or more additional iterations, until a completion condition is reached. Some non-limiting examples of a completion condition are a change in the updated parameter estimate that is smaller than a threshold amount or a threshold percentage (indicating that the iteration process has converged on a particular parameter estimate), and that a number of iterations has exceeded a threshold number (indicating that the iteration process is not converging and should be stopped). One non-limiting example of a threshold percentage is 0.01%.

Measurement adjustment module 240 uses the updated parameter estimate to adjust raw sensor data measured by its sensor device. The result is calibrated sensor data. In particular, if the raw sensor data at time k is denoted by x_{i,k}, the calibrated sensor data is Hᵢ*x_{i,k}.

Application 200 periodically repeats the iterations of the parameter estimation process. For example, application 200 might repeat the process every hour, or every six, twelve, or twenty-four hours. The time period selected depends on the sensors and the application in which they are used.

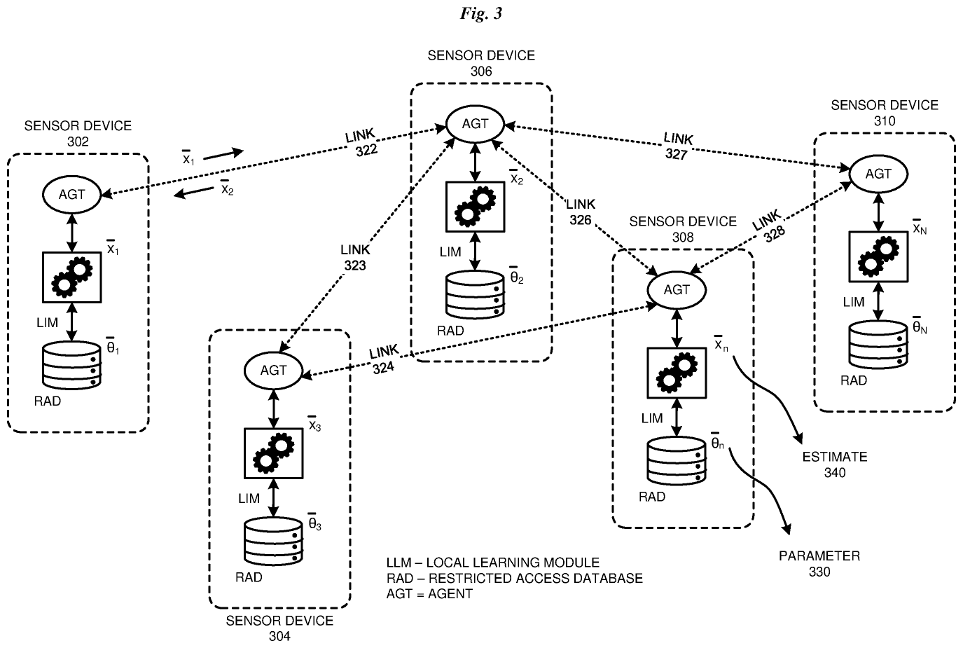

With reference to FIG. 3, this figure depicts an example configuration for sensor calibration using distributed stochastic parameter estimation in accordance with an illustrative embodiment. The example can be executed using application 200 in FIG. 2.

In particular, FIG. 3 depicts a network of sensor devices, including sensor devices 302, 304, 306, 308, and 310. Sensor devices 302, 304, 306, 308, and 310 are connected by communication links 322, 323, 324, 326, 327, and 328 as shown. Each sensor device includes a database of measurement data modeled by a model represented by parameter θ (e.g., parameter 330). Data in the database of measurement data is not typically sent to another sensor device (although this is possible). Each sensor device also includes xᵢ, (e.g., estimate 340), an estimate of the device's parameter θ. Estimates xᵢ, are sent to another sensor device, as depicted for link 322.

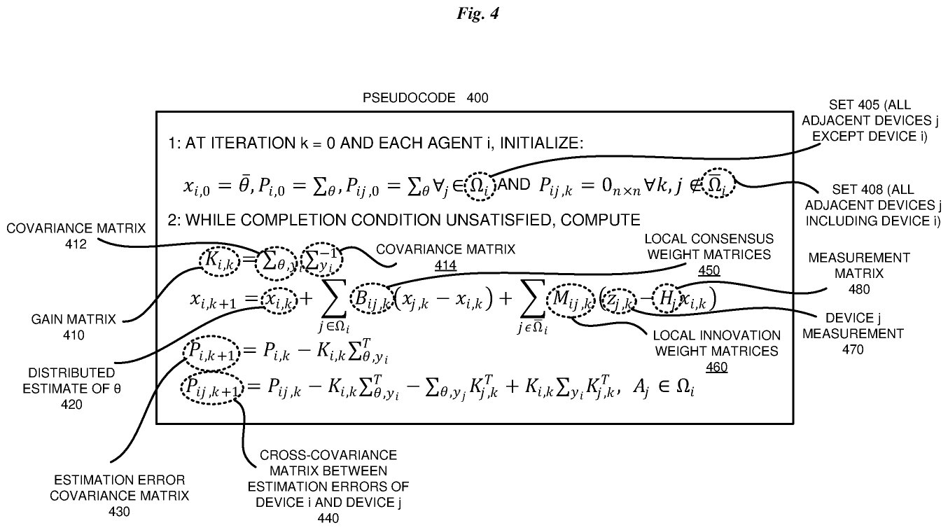

With reference to FIG. 4, this figure depicts example pseudocode for use in implementing sensor calibration using distributed stochastic parameter estimation in accordance with an illustrative embodiment. The example pseudocode can be executed using application 200 in FIG. 2.

In particular, within pseudocode 400, in line 1, P_{i,0}, P_{ij,0}, and x_{i,0} are initialized to previous statistics if available using the expressions depicted. Within the expressions in line 1, set 405 denotes all adjacent (connected by one communication link, or represented by one edge of a graph in which the devices are represented by nodes) devices j except for device i. Set 408 denotes all adjacent devices j including device i.

Line 2 of pseudocode 400 denotes the beginning of a loop, in which gain matrix 410 (denoted by K_{i,k}), distributed estimate of θ 420 (denoted by x_{i,k+1}), estimation error covariance matrix 430 (denoted by P_{i,k+1}), and cross-covariance matrix between estimation errors of devices i and j 440 (denoted by P_{ij,k+1}), using the expressions depicted. Within the expressions, covariance matrix 412, covariance matrix 414, local consensus weight matrices 450, local innovation weight matrices 460, device i measurement 470, and measurement matrix 480 of device j are represented as depicted.

With reference to FIG. 5, this figure depicts definitions for terms used in implementing sensor calibration using distributed stochastic parameter estimation in accordance with an illustrative embodiment.

In particular, FIG. 5 depicts definitions 510, 520, 530, 540, 550, 560, 570, and 580 for terms used in pseudocode 400 in FIG. 4 and in other definitions in FIG. 5. 512 denotes the number of elements in set 408 in FIG. 4. 514 denotes the number of elements in set 405 in FIG. 4. 532 denotes a local innovation matrix, a combination of the local observation matrices and some identity matrices. In definitions 550 and 580, the R matrices are the covariance of the measurement noises. The higher the R matrices, the worse (or inaccurate) the measurements are at each node. In the expressions, the O terms represent matrices with values of zero, and blkdiag denotes a block diagonal matrix (a square diagonal matrix in which the diagonal elements are themselves square matrices, and the off-diagonal elements are zero).

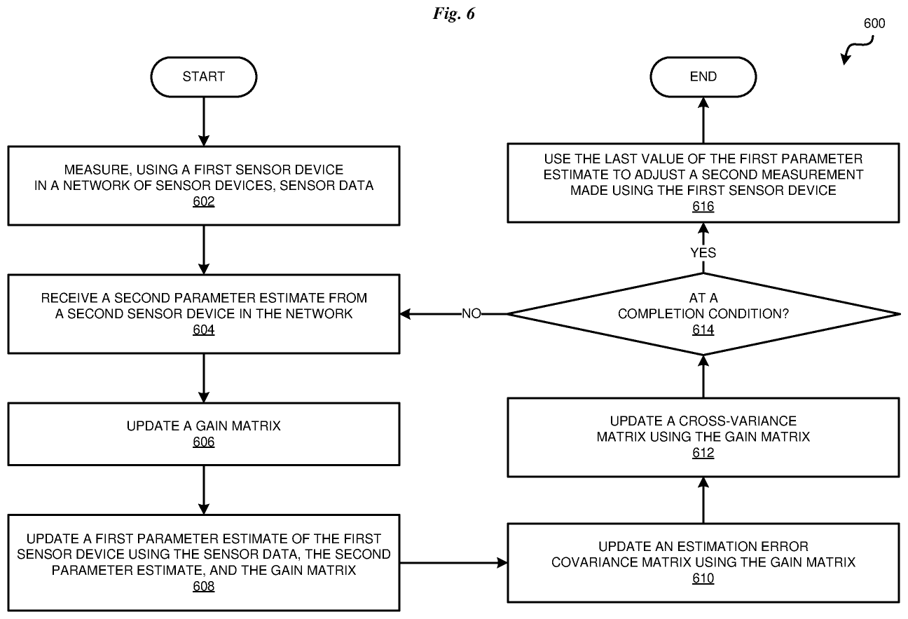

With reference to FIG. 6, this figure depicts a flowchart of an example process for sensor calibration using distributed stochastic parameter estimation in accordance with an illustrative embodiment. Process 600 can be implemented in application 200 in FIG. 2.

In block 602, the application measures, using a first sensor device in a network of sensor devices, sensor data. In block 604, the application receives a second parameter estimate from a second sensor device in the network. In block 606, the application updates a gain matrix. In block 608, the application updates a first parameter estimate of the first sensor device using the sensor data, the second parameter estimate, and the gain matrix. In block 610, the application updates an estimation error covariance matrix using the gain matrix. In block 612, the application updates a cross-variance matrix using the gain matrix. In block 614, the application determines whether it is at a completion condition. If not (“NO” path of block 614), the application returns to block 604. If yes (“YES” path of block 614), inn block 616, the application uses the last value of the first parameter estimate to adjust a second measurement made using the first sensor device. Then the application ends.

Thus, a computer implemented method, system or apparatus, and computer program product are provided in the illustrative embodiments for sensor calibration using distributed stochastic parameter estimation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
measuring, using a first sensor device in a network of sensor devices, sensor data;
selecting, from the network of sensor devices, a second sensor device, the second sensor device comprising a trusted sensor device;
updating a gain matrix;
updating, using the gain matrix, the sensor data, and a second parameter estimate received from the second sensor device, a first parameter estimate, the first parameter estimate comprising an estimate of a parameter of a model representing the first sensor device, the updating resulting in an updated first parameter estimate;
updating, using the gain matrix, an estimation error covariance matrix and a cross-variance matrix; and
adjusting, using the updated first parameter estimate, second sensor data measured by the first sensor device.

2. The computer-implemented method of claim 1, wherein the second sensor device comprises a geographically closest device to the first sensor device.

3. The computer-implemented method of claim 1, wherein the second sensor device comprises a sensor device having a direct communication connection to the first sensor device.

4. The computer-implemented method of claim 1, further comprising:
repeating, using new sensor data measured by the first sensor and a new parameter estimate received from the second sensor device, the updating of the first parameter estimate until a completion condition is satisfied.

5. The computer-implemented method of claim 4, wherein the completion condition comprises a change in the updated first parameter estimate that is less than a threshold percentage.

6. The computer-implemented method of claim 1, further comprising:
repeating, upon expiration of a predetermined time period, using new sensor data measured by the first sensor and new parameter estimates received from a newly selected sensor device in the network of sensor devices, the updating of the first parameter estimate until the completion condition is satisfied.

7. A computer program product comprising one or more computer readable storage medium, and program instructions collectively stored on the one or more computer readable storage medium, the program instructions executable by a processor to cause the processor to perform operations comprising:
measuring, using a first sensor device in a network of sensor devices, sensor data;
selecting, from the network of sensor devices, a second sensor device, the second sensor device comprising a trusted sensor device;
updating a gain matrix;
updating, using the gain matrix, the sensor data, and a second parameter estimate received from the second sensor device, a first parameter estimate, the first parameter estimate comprising an estimate of a parameter of a model representing the first sensor device, the updating resulting in an updated first parameter estimate;
updating, using the gain matrix, an estimation error covariance matrix and a cross-variance matrix; and
adjusting, using the updated first parameter estimate, second sensor data measured by the first sensor device.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the second sensor device comprises a geographically closest device to the first sensor device.

11. The computer program product of claim 7, wherein the second sensor device comprises a sensor device having a direct communication connection to the first sensor device.

12. The computer program product of claim 7, further comprising:
repeating, using new sensor data measured by the first sensor and a new parameter estimate received from the second sensor device, the updating of the first parameter estimate until a completion condition is satisfied.

13. The computer program product of claim 12, wherein the completion condition comprises a change in the updated first parameter estimate that is less than a threshold percentage.

14. The computer program product of claim 7, further comprising:
repeating, upon expiration of a predetermined time period, using new sensor data measured by the first sensor and new parameter estimates received from a newly selected sensor device in the network of sensor devices, the updating of the first parameter estimate until the completion condition is satisfied.

15. A computer system comprising a processor and one or more computer readable storage media, and program instructions collectively stored on the one or more computer readable storage media, the program instructions executable by the processor to cause the processor to perform operations comprising:
measuring, using a first sensor device in a network of sensor devices, sensor data;
selecting, from the network of sensor devices, a second sensor device, the second sensor device comprising a trusted sensor device;
updating a gain matrix;
updating, using the gain matrix, the sensor data, and a second parameter estimate received from the second sensor device, a first parameter estimate, the first parameter estimate comprising an estimate of a parameter of a model representing the first sensor device, the updating resulting in an updated first parameter estimate;
updating, using the gain matrix, an estimation error covariance matrix and a cross-variance matrix; and
adjusting, using the updated first parameter estimate, second sensor data measured by the first sensor device.

16. The computer system of claim 15, wherein the second sensor device comprises a geographically closest device to the first sensor device.

17. The computer system of claim 15, wherein the second sensor device comprises a sensor device having a direct communication connection to the first sensor device.

18. The computer system of claim 15, further comprising:
repeating, using new sensor data measured by the first sensor and a new parameter estimate received from the second sensor device, the updating of the first parameter estimate until a completion condition is satisfied.

19. The computer system of claim 18, wherein the completion condition comprises a change in the updated first parameter estimate that is less than a threshold percentage.

20. The computer system of claim 15, further comprising:
repeating, upon expiration of a predetermined time period, using new sensor data measured by the first sensor and new parameter estimates received from a newly selected sensor device in the network of sensor devices, the updating of the first parameter estimate until the completion condition is satisfied.
